(19) United States
(12) Patent Application Publication
(10) Pub. No.: US 2011/0042980 A1
(43) Pub. Date: Feb. 24, 2011

(54) Shovel apparatus

(76) Inventor: William W. Wiseman, II, Somerton, AZ (US)

Correspondence Address: William W. Wiseman II, P.O. Box 2875, Somerton, AZ, 85350, US

(21) Appl. No.: 12/583,460

(22) Filed: Aug. 24, 2009

(51) Int. Cl. A01B 1/02; B07B 1/02

(52) U.S. Cl. 294/49; 209/419

(57) ABSTRACT

A shovel apparatus having a handle assembly at one end, a blade at the other opposed end, and a shaft therebetween connecting the blade to the handle assembly. The blade, in turn, comprises a substantially flat, somewhat trapezoid-shaped base portion and an integral, continuous wall portion upstanding from the edge of the base portion on three sides thereof to form generally a scoop. The fourth edge of the base member defines an opening for the scoop and also defines a substantially straight leading edge of the blade. A pattern of openings, preferably in form of groups of elongated slots, is provided in the body member and in at least a portion of the upstanding continuous wall portion.

### BACKGROUND OF THE INVENTION

1. Field of the Invention

The present invention relates generally to hand tools in the form of a shovel, spade, or like apparatus, and more particularly, to a shovel or spade apparatus especially adapted for efficiently separating course debris such as rocks or pebbles from an agglomerate consisting of the debris and soil, dirt, sand or the like.

2. Description of the Prior Art

Shovels with perforated blades for sifting agglomerate from soil are well known in the art. For example, in U.S. Pat. No. 5,810,407 to Melendez et al, incorporated herein by this reference, there is described and illustrated a shovel having a latticework of perforations extending substantially throughout the entire expanse of the flat portion of the shovel's blade. The perforations or openings defined by the latticework are numerous, relatively small, and disposed in interleaving rows and columns. Such a shovel construction is difficult and expensive to fabricate, must be worked vigorously to separate the agglomerate from the soil, and is susceptible to clogging reducing its efficiency. A need exits therefore for a shovel apparatus having a perforated blade where the pattern of perforations is less expensive to formulate than an expansive interleaved design, which requires less working of the shovel to more easily separate coarse debris from the agglomerate picked up by the blade, and which furthermore is less susceptible of clogging and easier to maintain clean. The foregoing desired characteristics and advantages are provided by the unique shovel apparatus of the present invention as will be made apparent from the following description thereof. Other advantages of the present invention over the prior art also will be rendered evident.

### SUMMARY OF THE INVENTION

To achieve the foregoing and other advantages, the present invention, briefly described, provides a shovel apparatus having a hand grip assembly at one end, a blade at the other opposed end, and a handle or shaft therebetween connecting the blade to the hand grip assembly. The blade, in turn, comprises a substantially flat somewhat trapezoid-shaped base portion and an integral, continuous wall portion upstanding from the edge of the body member on three sides thereof to form generally a scoop. The fourth edge of the body member corresponding to the base of the trapezoid defining same, defines an opening for the scoop and also defines a substantially straight leading edge of the blade. A pattern of openings, preferably in form of groups of elongated slots, is provided in the body member and in the continuous wall portion. In use, an agglomerate such as, for example, a mixture of rocks and soil may be scooped up by the blade, and upon suitable shaking movement of the blade, the smaller soil particles are urged to drop to the ground through the openings leaving only the larger debris (e.g. rocks) retained in the blade or scoop. The large debris next efficiently may be disposed of as by dumping it into a nearby wheel barrow or the like.

The above brief description sets forth rather broadly the more important features of the present invention in order that the detailed description thereof that follows may be better understood, and in order that the present contributions to the art may be better appreciated. There are, of course, additional features of the invention that will be described hereinafter and which will be for the subject matter of the claims appended hereto.

In this respect, before explaining a preferred embodiment of the invention in detail, it is understood that the invention is not limited in its application to the details of the construction and to the arrangements of the components set forth in the following description or illustrated in the drawings. The invention is capable of other embodiments and of being practiced and carried out in various ways. Also, it is to be understood, that the phraseology and terminology employed herein are for the purpose of description and should not be regarded as limiting.

As such, those skilled in the art will appreciate that the conception, upon which disclosure is based, may readily be utilized as a basis for designing other structures, methods, and systems for carrying out the several purposes of the present invention. It is important, therefore, that the claims be regarded as including such equivalent constructions insofar as they do not depart from the spirit and scope of the present invention.

It is therefore an object of the present invention to provide a new and improved interchangeable shovel apparatus which has all of the advantages of the prior art and none of the disadvantages.

It is another object of the present invention to provide a new and improved shovel apparatus which may be easily and efficiently manufactured and marketed.

It is a further object of the present invention to provide a new and improved shovel apparatus which is of durable and reliable construction.

An even further object of the present invention is to provide a new and improved interchangeable head shovel apparatus which is susceptible of a low cost of manufacture with regard to both materials and labor, and which accordingly is then susceptible of low prices of sale to the consuming public, thereby making such shovel apparatus available to the buying public.

Still yet a further object of the present invention is to provide a new and improved shovel apparatus having a handle and a blade attached to the handle where the blade includes a series of perforations therein.

Still a further object of the present invention is to provide a new and improved shovel apparatus having a perforated blade where the perforations comprise a series of elongated slots disposed in separate groupings with respect to the blade's expanse.

Still yet another object of the present invention is to provide a new and improved shovel apparatus having a perforated blade where the perforations comprise a series of elongated slots disposed in separate groupings with respect to the blade's expanse, and where the elongated slots in at least one of the groupings are of unequal axial extent or length.

Yet another object of the present invention is to provide a new and improved shovel apparatus including a perforated blade and where the blade includes an upstanding continuous sidewall portion extending backwardly with respect to the blade's leading edge and where the perforations in the blade are disposed partly in the flat expanse of the blade and partly in the upstanding continuous sidewall portion thereof.

These together with still other objects of the invention, along with the various features of novelty which characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there are illustrated preferred embodiments of the invention.

### BRIEF DESCRIPTION OF THE DRAWINGS

The invention will be better understood and the above objects as well as objects other than those set forth above will become more apparent after a study of the following detailed description thereof. Such description makes reference to the annexed drawing wherein:

FIG. 1 is a perspective view schematically showing the blade portion of the shovel apparatus of the invention in use digging into the ground picking up an agglomerate or mixture of course debris (e.g. rocks) and soil.

FIG. 2 is a perspective view of the blade portion of the shovel apparatus of FIG. 1 schematically showing it in use in an elevated position after it has been shaken or otherwise moved to cause the soil in the mixture to pass through the openings in the blade leaving only the course debris retained in the blade.

FIG. 3 is plan view of a preferred embodiment of the shovel apparatus of the invention.

FIG. 4 is a side view of a portion of the shovel apparatus of FIG. 3 taken along line 4-4 thereof.

FIG. 5 is a cross-sectional view of a portion of the shovel apparatus of FIG. 3 taken along line 5-5 thereof.

FIG. 6 is a cross-sectional view of a portion of the shovel apparatus of FIG. 3 taken along line 6-6 thereof.

### DESCRIPTION OF THE PREFERRED EMBODIMENT

With reference to the drawings, a new and improved shovel apparatus embodying the principles and concepts of the present invention will be described.

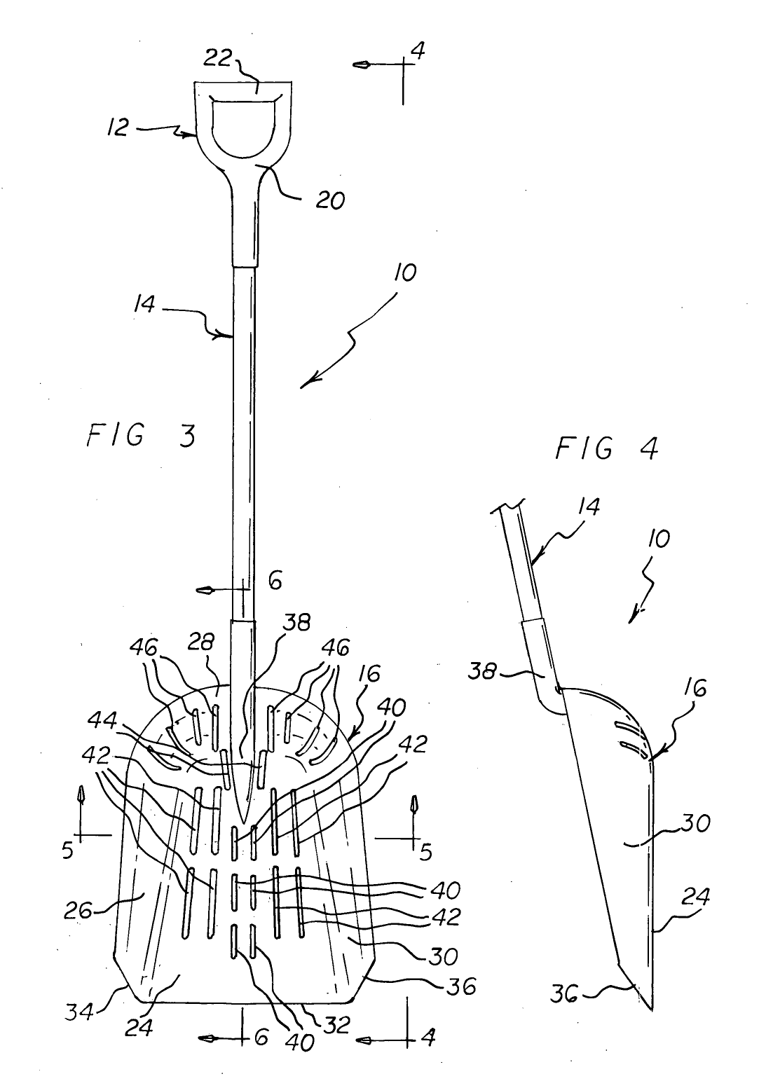

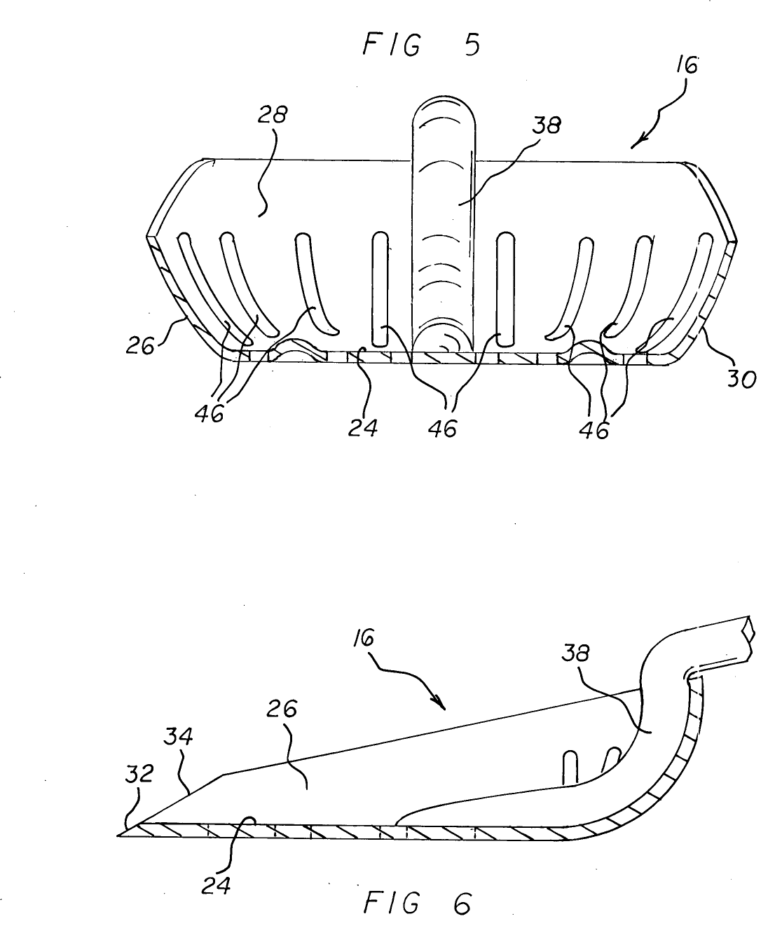

Turning initially to FIGS. 3-6, there is shown a preferred embodiment of the shovel apparatus of the present invention generally represented by reference numeral 10. Shovel apparatus 10 essentially comprises three primary components namely, a hand grip assembly 12 at one end, a handle in the form of an elongated shaft 14 suitably connected to the hand grip assembly 12, and a blade 16 suitably connected to the other end of shaft or handle 14 substantially as depicted. Hand grip assembly 12 comprises a Y-shaped portion 20 defining a socket for recaption of a first or one end of handle 14 and a transverse hand grip member 22.

Blade 16 includes a substantially flat base portion 24 of generally trapezoidal shape and a an upstanding continuous sidewall having a left portion 26, a rear portion 28 and a right portion 30 (FIG. 3) integral with base portion 24. By this construction, the continuous sidewall and base portion defines a scoop or shallow bucket for digging into the ground and picking up a load of dirt, or soil or the like. To aid the penetration of the blade into the ground, the base portion preferably has a leading edge 32 which is beveled or sharpened (FIG. 6). Left sidewall portion 26 and right sidewall portion 30 also preferably have a beveled or sharpened leading edge 34, 36 for the same purpose.

A transition member 38 is located on the central longitudinal axis of shovel apparatus 10 and is suitably integrally attached to the rear sidewall portion 28 and to a portion of the base portion 24 substantially as depicted. Transition member 38 defines a socket (unsigned) for receiving the second or other end of handle 14 and provides a strong connection between handle 14 and blade 16. In the prior art, the transition member 38 sometimes is referred to as the “frog” of the shovel's blade.

In accordance with the invention, a unique pattern or series of perforations is provided in the blade 16, and more particularly, in the substantially flat base portion 24 and in the rear sidewall portion 28 thereof. Even more specifically, the perforations are in the form of elongated slots having different lengths. A first such grouping of slots 40, totaling six in number, are provided in axial alignment between the nose of the frog and the leading edge 32 of blade 16 and are preferably disposed in three rows of two each substantially as shown in FIG. 6. Disposed on either side of slots 40, is a second grouping of perforations in the form of elongated slots 42 arranged in two rows of separate pairs substantially as illustrated in FIG. 6. Preferably, the elongated extent of slots 42 is greater than the elongated extent of slots 40.

A third grouping of slots 44, comprising a single pair is disposed on either side of the nose of frog or transition member 38, respectively, substantially as depicted in FIG. 6, preferably with the length of slots 44 being greater than the length of slots 40, but less than the length of slots 42.

Finally, a fourth grouping of slots 46 are provide on either side of frog 38 in the rear sidewall portion 28, with the slots 46 being divided into two subgroups of four slots each, substantially as depicted in FIG. 6. The elongated extent of slots 46 is preferably is less than elongated extent of slots 42, but greater than the elongated extent of slots 44.

Generally speaking, the width of slots 40, 42, 44 and 46 (transverse dimension) is chosen to permit soil to pass easily therethrough, but to retain on the blade any course agglomerate or debris such as rocks, stones, shells, twigs or the like. For ease of manufacture, this transverse dimension of all slots may be the same. Additionally, it will be observed that slots 40 and 42 occupy a substantial area of the base portion 28, but for the relatively narrow band adjacent to leading edge 32. Similarly, slots 46 occupy a substantial area of rear sidewall portion 28.

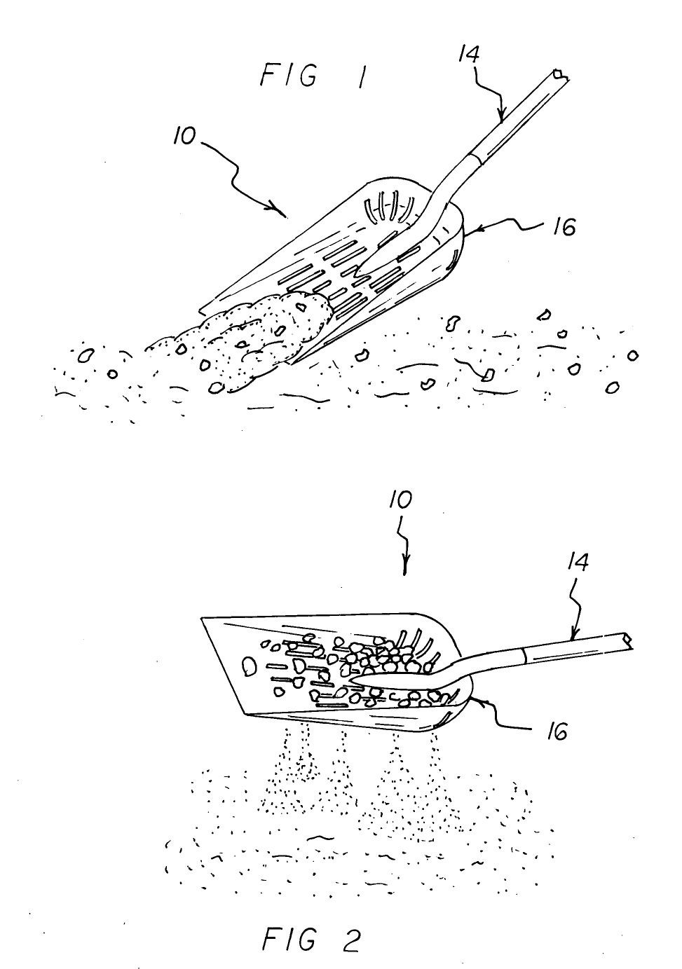

In use, the blade of shovel apparatus 10 is dug into the ground adequate to place a load of soil or agglomerate thereon. This is schematically depicted in FIG. 1. Next, the shovel apparatus is lifted in the air above the ground, shaken up-and-down and/or side-to-side to urge only the soil or fine medium on the blade to pass through the slots 40, 42, 44 and 46, all of the while retaining the course material in the agglomerate on the blade. This is depicted schematically in FIG. 2. Because of the unique disposition of the slots 40, 42, 44 and 46, sifting of the agglomerate by the foregoing method more quickly separates the course retained material from the finer soil or the like and with less energy of movement than would otherwise be expected. When substantially all the fine soil is dispensed through the blade perforations or slots, the remaining agglomerate debris or material may be placed easily in a nearby wheelbarrow or container, or simply placed in a pile on the ground.

The shovel apparatus of the invention may be manufactured easily using techniques well known in the art. In this respect, the slots 40, 42, 44, 46 are easily formed in the blade 16 by machining, or stamping on a press. Alternatively, the blade may be molded or otherwise formed of a single piece to include the slots. To further illustrate the invention without limitation, a stock shovel with an aluminum blade was purchased from a retail store. The blade of the shovel (size of about 652 mm×378 mm×2 mm) was milled to produce the pattern of slots shown in FIG. 6 and elsewhere in this application. The length of the slots ranged from about 1 and ¾ inches to about 3 and ¾ inches whereas the width or transverse dimension of the slots was about ½ inches. The shovel was used to sift rocky soil from a yard quickly, efficiently and with little effort compared to an unmodified stock shovel.

The components of the shovel apparatus of the invention can be made from inexpensive and durable metal, plastic or wood materials.

As to the manner of usage and operation of the instant invention, the same is apparent from the above disclosure, and accordingly, no further discussion relative to the manner of usage and operation need be provided.

It is apparent from the above that the present invention accomplishes all of the objects set forth by providing a new and improved shovel apparatus that is low in cost, relatively simple in design and operation, and which may advantageously be used to provide an efficient tool for sifting soil or the like and removing course material from the soil agglomerate such as rocks or other debris.

Thus, while the present invention has been shown in the drawings and fully described above with particularity and detail in connection with what is presently deemed to be the most practical and preferred embodiment(s) of the invention, it will be apparent to those of ordinary skill in the art that many modifications thereof may be made without departing from the principles and concepts set forth herein, including, but not limited to, variations in size, materials, shape, form, function and manner of operation, assembly and use.

Hence, the proper scope of the present invention should be determined only by the broadest interpretation of the appended claims so as to encompass all such modifications as well as all relationships equivalent to those illustrated in the drawings and described in the specification.

Finally, it will be appreciated that the purpose of the annexed Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. Accordingly, the Abstract is neither intended to define the invention or the application, which only is measured by the claims, nor is it intended to be limiting as to the scope of the invention in any way.

What is claimed as being new and desired to be protected by Letters Patent of the United States is as follows:

1. Shovel apparatus, comprising:
a handle,
a blade,
said blade being joined to said handle,
said blade having a substantially flat base portion and a continuous sidewall upstanding from said base portion to define a scoop, and
a pattern of openings,
said pattern of openings being divided into separate groups of openings, at least one of said separate groups of openings being disposed in said base portion, and at least another of said separate groups being disposed in said upstanding sidewall.

2. The apparatus of claim 1 wherein:
said openings are in the form of elongated slots.

3. The apparatus of claim 2 wherein:
said at least one of said separate groups of openings being disposed in said base portion comprises a first subgroup of openings having a first elongated extent and a second subgroup of openings having a second elongated extent.

4. The apparatus of claim 3 wherein said second elongated extent is greater in magnitude than said first elongated extent.

5. The apparatus of claim 4 wherein said openings in said first subgroup of openings having a first elongated extent and said openings in said second subgroup of openings having a second elongated extent each have a transverse extent, and said transverse extent is substantially equal.

6. The apparatus of claim 3 wherein at least one of said separate groups of openings disposed in said continuous sidewall upstanding from said base portion has a third elongated extent, and said third elongated extent is greater than said first elongated extent.

7. The apparatus of claim 3 wherein at least one of said separate groups of openings disposed in said continuous sidewall upstanding from said base portion has a third elongated extent, and said third elongated extent is less than said second elongated extent.

8. The apparatus of claim 6 wherein said continuous sidewall has a first sidewall portion, a second sidewall portion, and a rear portion situated between said first and second sidewall portions, and said at least another of said separate groups being disposed in said upstanding sidewall is disposed in said rear portion.

9. The apparatus of claim 4 wherein said first elongated extent and said second elongated extent is in the range of about 1 and ¾ inches to about 3 and ¾ inches.

10. The apparatus of claim 7 wherein said first elongated extent, said second elongated extent, and said third elongated extent is in the range of about 1 and ¾ inches to about 3 and ¾ inches.
